(19) United States
(12) Patent Application Publication
(10) Pub. No.: US 2015/0171780 A1
(43) Pub. Date: Jun. 18, 2015

(54) APPARATUS FOR DRIVING MOTOR AND CONTROLLING METHOD THEREOF

(71) Applicant: SAMSUNG ELECTRO-MECHANICS CO., LTD., Suwon-Si (KR)

(72) Inventors: Joo Yul KO, Suwon-Si (KR); Ki Chul KIM, Suwon-Si (KR); Sun Ho PARK, Suwon-Si (KR); Jong Woo LEE, Suwon-Si (KR)

(73) Assignee: SAMSUNG ELECTRO-MECHANICS CO., LTD., Suwon-Si (KR)

(21) Appl. No.: 14/303,577

(22) Filed: Jun. 12, 2014

(30) Foreign Application Priority Data
Dec. 18, 2013 (KR) 10-2013-0158493

(51) Int. Cl. H02P 6/18

(52) U.S. Cl. CPC H02P 6/182

(57) ABSTRACT

Disclosed herein is an apparatus for driving a motor, including: a rectifying unit rectifying alternative current (AC) input power to generate direct current (DC) power; an inverter applying the DC power to the respective phases of the motor through a switching operation thereof; and a motor driver converting back-electromotive force values sequentially sampled in floating sections of the respective phases into digital values and detecting position information of ZCPs of the respective phases through a pattern of back-electromotive force formed using comparison result values between the digital values and a reference voltage value.

### CROSS REFERENCE TO RELATED APPLICATION

This application claims the benefit of Korean Patent Application No. 10-2013-0158493, filed on Dec. 18, 2013, entitled “Apparatus for Driving Motor and Controlling Method Thereof”, which is hereby incorporated by reference in its entirety into this application.

### BACKGROUND OF THE INVENTION

1. Technical Field

The present invention relates to an apparatus for driving a motor and a controlling method thereof.

2. Description of the Related Art

Generally, a direct current (DC) motor has a linear relationship between an applied voltage and a speed, such that a speed control is simple and a speed control range is wide. However, since a brush should be necessarily used in the DC motor in order to maintain a torque in one direction, it is difficult to drive the DC motor at a high speed due to the brush, and maintenance of the DC motor should be frequently performed and noise, or the like, thereof is severe, due to abrasion of the brush.

In order to solve the above-mentioned problems, a brushless DC motor (hereinafter, referred to as a BLDC motor) including a stator around which a coil is wound and a rotor provided with a permanent magnet, as opposed to a general DC motor, and controlling a current flowing in the coil of the stator to control a magnetic flux of the stator and a magnetic flux of the permanent magnet of the rotor to have a right angle or any angle therebetween, thereby obtaining rotational force has been introduced.

Since the BLDC motor does not have the brush to solve disadvantages of an existing DC motor and has advantages of the DC motor as they are, it has been recently used widely. In the BLDC motor, switching states of inverter switching devices, or the like, should be determined so as to determine a magnetic flux generation position of the stator depending on a position of the rotor in order to appropriately control the magnetic flux. In order to determine the position of the rotor, a sensor such as a Hall sensor, or the like, may be used. However, a sensorless scheme of finding position information of the rotor by detecting a zero crossing point (ZCP) through back-electromotive force without a sensor due to environmental factors such as temperature, a pressure, and the like, has been mainly used.

Therefore, in the sensorless scheme, according to the prior art, the zero crossing point (ZCP) has been detected by comparing back-electromotive force of the respective phases induced from the stator with a reference voltage as disclosed in the following Prior Art Document (Patent Document). However, in the case in which a mismatch of inductors, or the like, a vibration, or the like, is generated in the BLDC motor, accuracy in detection of the zero crossing point (ZCP) is decreased, such that detection of the position of the rotor becomes inaccurate and a phase shifting point in time of the motor becomes irregular.

### PRIOR ART DOCUMENT

### Patent Document

(Patent Document 1) 2006-0068844KR

### SUMMARY OF THE INVENTION

The present invention has been made in an effort to provide an apparatus for driving a motor capable of more accurately detecting position information of a zero crossing point (ZCP) through a pattern of back-electromotive force formed using comparison result values between back-electromotive force values sequentially sampled in floating sections of the respective phases of a brushless direct current (BLDC) motor and a reference voltage value in order to secure reliability in driving the BLDC motor, and a controlling method thereof.

According to a preferred embodiment of the present invention, there is provided an apparatus for driving a motor, including: a rectifying unit rectifying alternative current (AC) input power to generate direct current (DC) power; an inverter applying the DC power to the respective phases of the motor through a switching operation thereof; and a motor driver converting back-electromotive force values sequentially sampled in floating sections of the respective phases into digital values and detecting position information of ZCPs of the respective phases through a pattern of back-electromotive force formed using comparison result values between the digital values and a reference voltage value.

The motor driver may convert the back-electromotive force values into the digital values by an analog-to-digital converter.

The motor driver may compare the back-electromotive force values converted into the digital values with the reference voltage value by a digital comparator to output the comparison result values.

The motor driver may sequentially accumulate the comparison result values to form the pattern of the back-electromotive force.

The motor driver may detect the position information of the ZCPs of the respective phases using position information of the changed comparison result values in the case in which the comparison result values sequentially accumulated in the pattern of the back-electromotive force have been changed.

The motor driver may judge validity of the position information of the ZCPs depending on whether or not comparison result values accumulated after the changed comparison result values form a predetermined pattern in the case in which the comparison result values sequentially accumulated in the pattern of the back-electromotive force have been changed.

The motor driver may perform phase shifting of the respective phases on the assumption that the position information of the ZCPs is valid in the case in which comparison result values having the same value after the changed comparison result values form a pattern continuously accumulated three times or more.

The motor driver may sequentially store the back-electromotive force values converted into the digital values by a first storing module.

The motor driver may sequentially store the comparison result values by a second storing module.

The motor driver generates pulse width modulation (PWM) signals for controlling the switching operation of the inverter and the phase shifting of the respective phases using the position information of the ZCPs.

The motor driver may include: a ZCP detecting unit converting the respective back-electromotive force values sequentially sampled in the floating sections of the respective phases into the digital values and detecting the position information of the ZCPs of the respective phases through the pattern of the back-electromotive force formed using the comparison result values between the digital values and the reference voltage value; and a PWM signal generating unit generating PWM signals for controlling the switching operation of the inverter and phase shifting of the respective phases using the position information of the ZCPs.

The ZCP detecting unit may include: an analog multiplexer sequentially transmitting the back-electromotive force values sampled in the floating sections of the respective phases; a converting module converting the back-electromotive force values of the respective phases transmitted from the analog multiplexer into the digital values; a digital comparator comparing the back-electromotive force values converted into the digital values with a preset reference voltage value to output the comparison result values; a back-electromotive force pattern detecting module forming the pattern of the back electromotive force using the comparison result values so that the comparison result values and the sampled back-electromotive force values correspond to each other; a ZCP calculating module calculating ZCP generation times (t_{ZCP}) using the position information of the ZCPs in the case in which the comparison result values configuring the pattern of the back-electromotive force are changed; and a controller judging validity of the position information of the ZCPs and the ZCP generation times (t_{ZCP}) depending on whether or not the comparison result values input from the digital comparator after the comparison result values are changed form a predetermined pattern.

The ZCP detecting unit may include a first storing module including first to fifth registers in which the back-electromotive force values converted into the digital values are sequentially stored.

The ZCP detecting unit may include a second storing module including first to sixth registers in which the comparison result values are sequentially stored.

According to another preferred embodiment of the present invention, there is provided a controlling method of an apparatus for driving a motor, including: rectifying, by a rectifying unit, AC input power to generate DC power; applying the DC power to the respective phases of the motor through a switching operation of an inverter; and converting back-electromotive force values sequentially sampled in floating sections of the respective phases into digital values and detecting position information of ZCPs of the respective phases through a pattern of back-electromotive force formed using comparison result values between the digital values and a reference voltage value.

The detecting of the position information of the ZCPs of the respective phases may include: converting the back-electromotive force values sequentially sampled in the floating sections of the respective phases into the digital values and detecting the position information of the ZCPs of the respective phases through the pattern of the back-electromotive force formed using the comparison result values between the digital values and a reference voltage value; and generating PWM signals for controlling the switching operation and phase shifting of the respective phases using the position information of the ZCPs.

The detecting of the position information of the ZCPs of the respective phases may include: sequentially transmitting the back-electromotive force values sampled in the floating sections of the respective phases; converting the back-electromotive force values of the respective phases that are transmitted into the digital values; comparing the back-electromotive force values converted into the digital values with a preset reference voltage value to output the comparison result values; sequentially accumulates the comparison result values to form the to pattern of the back-electromotive force; detecting whether or not the ZCPs have been generated and ZCP generation times (t_{ZCP}) depending on whether or not the comparison result values configuring the pattern of the back-electromotive force has been changed; and judging validity of the position information of the ZCPs depending on whether or not comparison result values accumulated after the changed comparison result values form a predetermined pattern in the case in which the comparison result values sequentially accumulated in the pattern of the back-electromotive force have been changed.

In the judging validity of the position information of the ZCPs, the validity of the position information of the ZCPs may be judged depending on whether or not the comparison result values accumulated after the changed comparison result values form the predetermined pattern in the case in which the comparison result values sequentially accumulated in the pattern of the back-electromotive force have been changed.

The detecting of the position information of the ZCPs of the respective phases may further include, after the converting of the back-electromotive force values of the respective phases into the digital values, sequentially storing back-electromotive force values converted into the digital values in first to fifth registers.

The detecting of the position information of the ZCPs of the respective phases may further include, after the outputting of the comparison result values, sequentially storing the comparison result values in first to sixth registers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for driving a motor according to a preferred embodiment of the present invention;

FIG. 2 a is an entire circuit diagram showing the apparatus for driving a motor according to a preferred embodiment of the present invention;

FIG. 3 is a diagram showing a controlling method of an apparatus for driving a motor according to a preferred embodiment of the present invention;

FIG. 4A to 4C is a diagram showing a configuration of a zero crossing point (ZCP) according to a preferred embodiment of the present invention;

FIGS. 5A to 6B are diagrams for describing processes of detecting ZCPs in a section \textcircled{0} and a section \textcircled{2} and calculating ZCP generation times (t_{ZCP}).

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

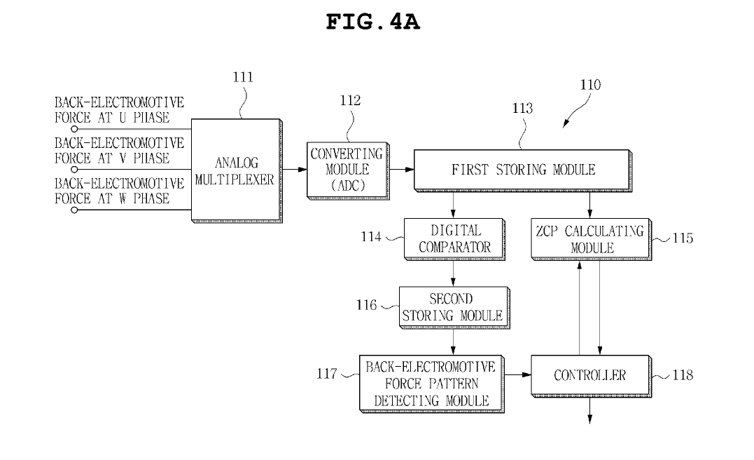

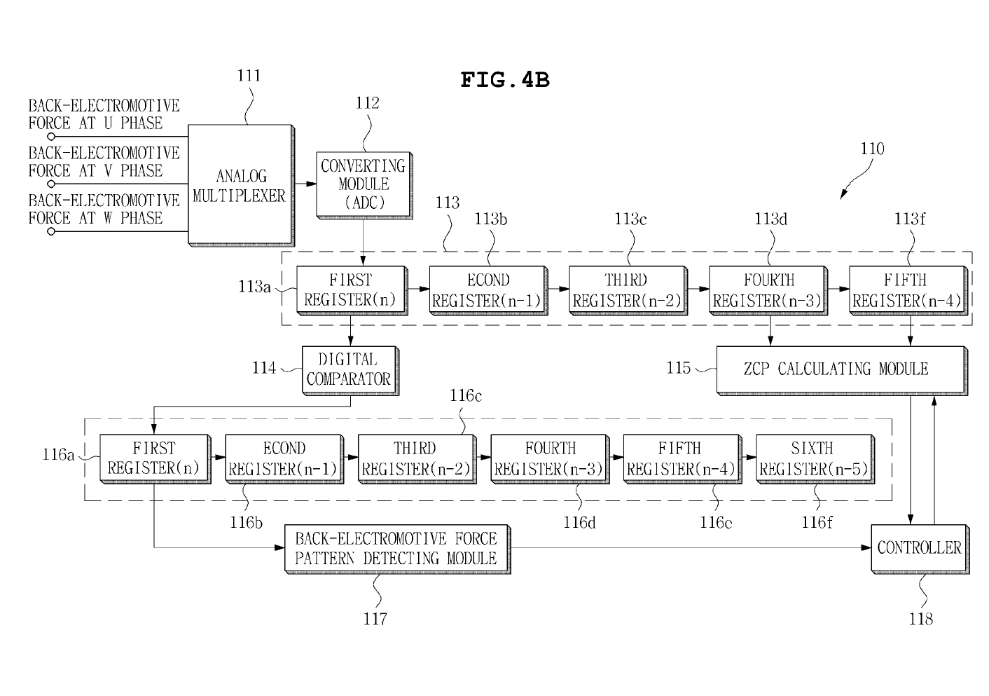

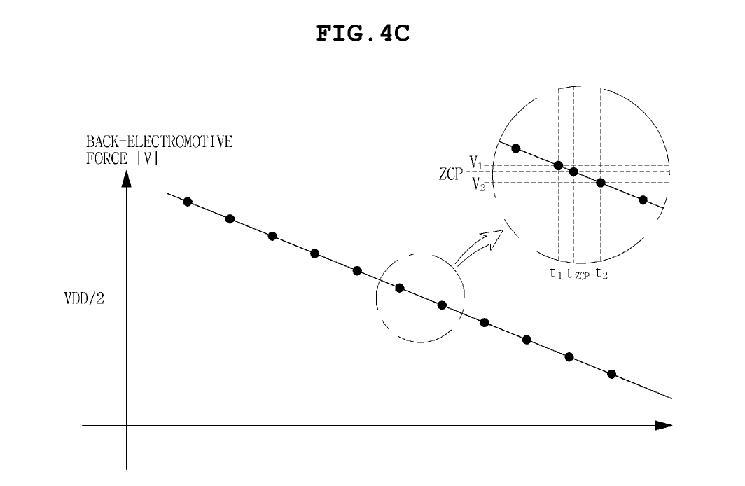

Hereinafter, an apparatus for driving a motor and a controlling method thereof according to a preferred embodiment of the present invention will be described in detail with reference to the accompanying drawings. A zero crossing point (ZCP) indicates a point (t_{ZCP}, V_{DD}/2) at which back-electromotive force of the respective phases (phase voltages in floating sections of the respective phases) intersects with a reference voltage (voltage at a neutral point, V_{DD}/2), as shown in FIG. 4C, and a ZCP generation time (t_{ZCP}) may be calculated by Equations 1 and 2.

$$\begin{matrix}\frac{{V}_{DD}}{2} = \frac{{V}_{1} - {V}_{2}}{{t}_{1} - {t}_{2}} ( {t}_{ZCP} - {t}_{1} ) + {V}_{1} & [ Equation 1 ] \\ {t}_{ZCP} = \frac{{t}_{1} - {t}_{2}}{{V}_{1} - {V}_{2}} ( \frac{{V}_{DD}}{2} - {V}_{1} ) + {t}_{1} & [ Equation 2 ]\end{matrix}$$

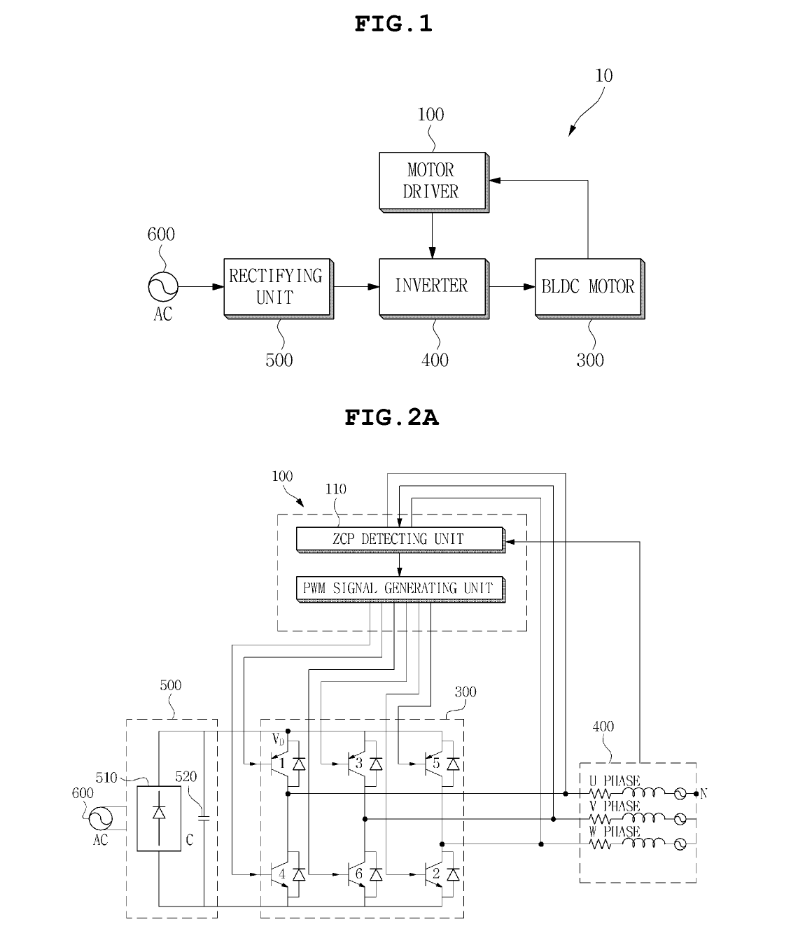

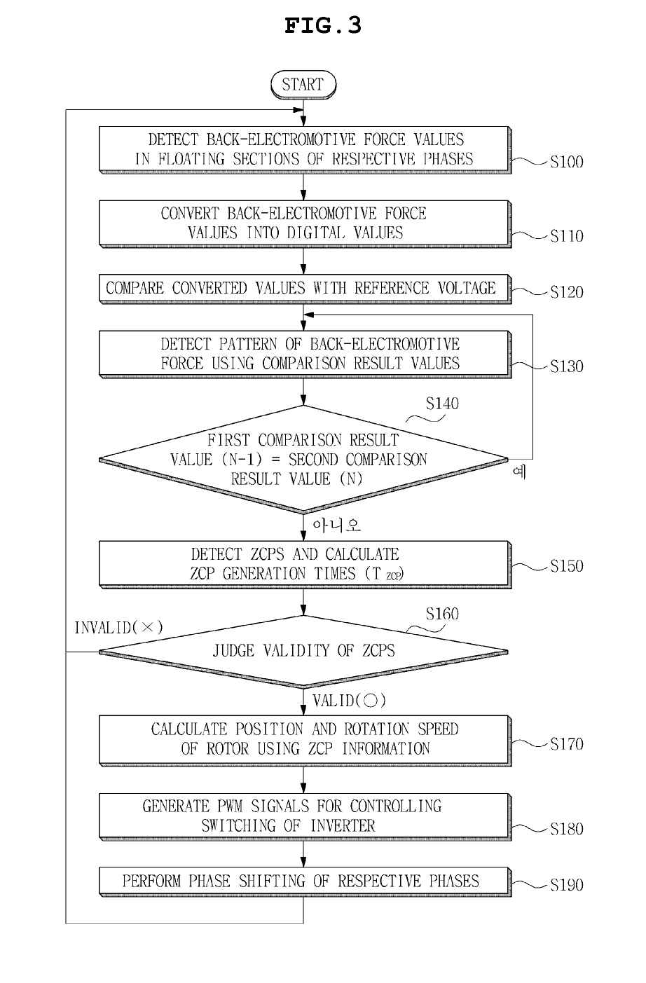

As shown in FIGS. 1 to 3, an apparatus for driving a motor according to a preferred embodiment of the present invention is configured to include an input power supply 600, a rectifying unit 500, a motor driver 100, an inverter 300, and a brushless direct current (BLDC) motor 400.

The rectifying unit 500 includes a rectifier 510 receiving and rectifying alternating current (AC) input power and a smoothing capacitor 520 smoothing the rectified input power and applies the rectified and smoothed DC voltage to the inverter 300.

The inverter 300 receives the rectified and smoothed DC voltage applied through the rectifying unit 500 and applies the DC voltage to the respective phases of the BLDC motor through a switching operation thereof, and may include first to sixth transistors controlled by a pulse width modulation (PWM) signal of the motor driver 100 and diodes connected in inversely parallel with the transistors, respectively. The inverter 300 may receive a DC voltage by a DC power supply instead of the rectifying unit 500.

The motor driver 100 may convert back-electromotive force values sequentially sampled in floating sections of the respective phases of the BLDC motor into digital values and detect position information of ZCPs of the respective phases through a pattern of back-electromotive force formed using comparison result values between the digital values and a reference voltage value.

That is, the motor driver 100 may convert the back-electromotive force values sequentially sampled in the floating sections of the respective phases of the BLDC motor into the digital values by an analog-to-digital converter (S100 and S110), compare the back-electromotive force values converted into the digital values with the reference voltage value by a digital comparator (S120), and sequentially accumulate the output comparison result values to form the pattern of the back-electromotive force (S130).

Further, the motor driver 100 may judge whether or not the comparison result values sequentially accumulated in the pattern of the back-electromotive force have been changed (S140), may detect the position information of the ZCPs of the respective phases using position information of changed comparison result values in the case in which the comparison result values are changed, may judge validity of the position information of the ZCPs depending on whether or not comparison result values accumulated after the changed comparison result values form a predetermined pattern (S160) in the case in which the comparison result values sequentially accumulated in the pattern of the back-electromotive force are changed, may sequentially store the back-electromotive force values converted into the digital values by a first storing module 113, and may sequentially store the comparison result values by a second storing module 116.

The motor driver 100 may measure a position and a rotation speed of a rotor (not shown) using the position information of the ZCPs (S170) on the assumption that the position information of the ZCPs is valid in the case in which comparison result values having the same value after the changed comparison result values form a pattern continuously accumulated three times or more and may generate pulse width modulation (PWM) signals for controlling a switching operation of the inverter 300 and phase shifting of the respective phases (S180) to perform the phase shifting of the respective phases (S190).

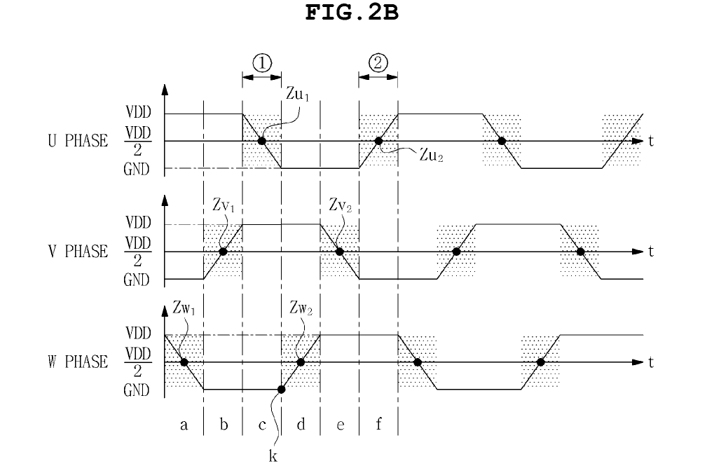

That is, as shown in FIGS. 2A and 2B, phase voltages of the respective phases of the BLDC motor are changed in a trapezoidal shape, and the respective phases (U phase, V phase, and W phase) include a section in which power V_{dd} is applied, a ground section GND, and a floating section (section in which the power is not applied, dotted region). In addition, through sections a to f, the rotor (not shown) of the BLDC motor is rotated by 360 degrees, and generally, when the ZCP is detected, phase shifting is performed after an electric angle of 30 degrees from the ZCP.

That is, referring to FIGS. 2A and 2B, through the PWM signal, the motor driver 100 i) turns on the first and sixth transistors (hereinafter, referred to as TR) in the section a, such that the U phase may become the power V_{dd}, the V phase may become the GND, the W phase may be floated, and the ZCP may be detected in the W phase, ii) turns on the first and second TRs in the section b, such that the U phase may become the power V_{dd}, the V phase may be floated, the W phase may become the GND, and the ZCP may be detected in the V phase, and iii) turns on the third and second TRs in the section c, such that the U phase may be floated, the V phase may become the power V_{dd}, the W phase may become the GND, and the ZCP may be detected in the U phase.

In addition, the motor driver 100 iv) turns on the fourth and third TRs in the section d, such that the U phase may become the GND, the V phase may become the power V_{dd}, the W phase may be floated, and the ZCP may be detected in the W phase, v) turns on the fourth and fifth TRs in the section e, such that the U phase may become the GND, the V phase may be floated, the W phase may become the power V_{dd}, and the ZCP may be detected in the V phase, and vi) turns on the sixth and fifth TRs in the section f, such that the U phase may be floated, the V phase may become the GND, the W phase may become the power V_{dd}, and the ZCP may be detected in the U phase.

As described above, with the apparatus for driving a motor according to a preferred embodiment of the present invention, in a sensorless scheme of detecting the ZCPs through the back-electromotive force of the respective phases to find position information of the rotor, a ZCP detecting unit sequentially samples the back-electromotive force values in the floating sections of the respective phases, forms the pattern of the back-electromotive force using the comparison result values between the back-electromotive force values and the reference voltage value (voltage at a neutral point, V_{DD}/2) by the digital comparator, and detects the position information of the ZCPs depending on whether or not the comparison result values on the pattern of the back-electromotive force have been changed, thereby making it possible to more accurately detect the position information of the ZCPs of the respective phases as compared with the case of detecting the ZCPs of the respective phases by an analog comparator.

Next, detection of ZCPs by the ZCP detecting unit of the apparatus for driving a motor according to a preferred embodiment of the present invention and ZCP generation times (t_{ZCP}) will be described in more detail with reference to FIGS. 4A to 4C.

The motor driver 100 may convert the back-electromotive force values sequentially sampled in the floating sections of the respective phases into the digital values and detect the position information of the ZCPs of the respective phases through the pattern of the back-electromotive force formed using the comparison result values between the digital values and the reference voltage value, and may include the ZCP detecting unit 110 and a PWM signal generating unit 120.

The ZCP detecting unit 110 may convert the respective back-electromotive force values sequentially sampled in the floating sections of the respective phases of the BLDC motor into the digital values and detect the position information of the ZCPs of the respective phases through the pattern of the back-electromotive force formed using the comparison result values between the digital values and the reference voltage value, and may include an analog multiplexer 111, a converting module 112, a first storing module 113, a digital comparator 114, a second storing module 116, a back-electromotive force pattern detecting module 117, a ZCP calculating module 115, and a controller 118.

The ZCP detecting unit 110 may include the analog multiplexer 111 sequentially receiving the back-electromotive force values sampled in the floating sections of the respective phases (U, V and W phases), the converting module 112 converting the back-electromotive force values of the respective phases transmitted from the analog multiplexer 111 into the digital values, the digital comparator 114 comparing the back-electromotive force values converted into the digital values with a preset reference voltage value to output the comparison result values, and the back-electromotive force pattern detecting module 117 forming the pattern of the back electromotive force by sequentially accumulating the comparison result values so that the comparison result value and the sampled back-electromotive force values correspond to each other. Here, the converting module 112 may be an analog-to-digital converter.

Further, the ZCP detecting unit 110 may include the ZCP calculating module 115 calculating the ZCP generation times (t_{ZCP}) using the position information of the ZCPs in the case in which the comparison result values configuring the pattern of the back-electromotive force are changed and the controller 118 judging the validity of the position information of the ZCPs and the ZCP generation times (t_{ZCP}) depending on whether or not the comparison result values input from the digital comparator after the comparison result values are changed form a predetermined pattern.

Here, the ZCP detecting unit 110 may sequentially store the back-electromotive force values converted into the digital values by the first storing module 113 including first to fifth registers 113a to 113f (8 bits) and may sequentially store the comparison result values by the to second storing module 116 including first to sixth registers 116a to 116f (1 bit), wherein the resisters may be flip-flops.

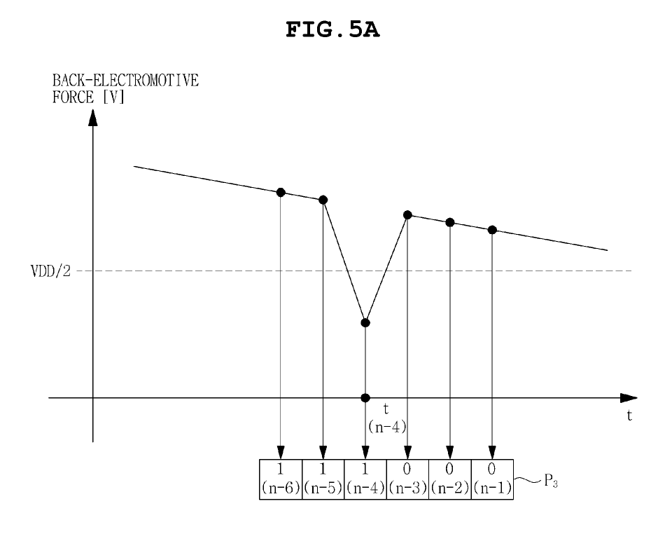

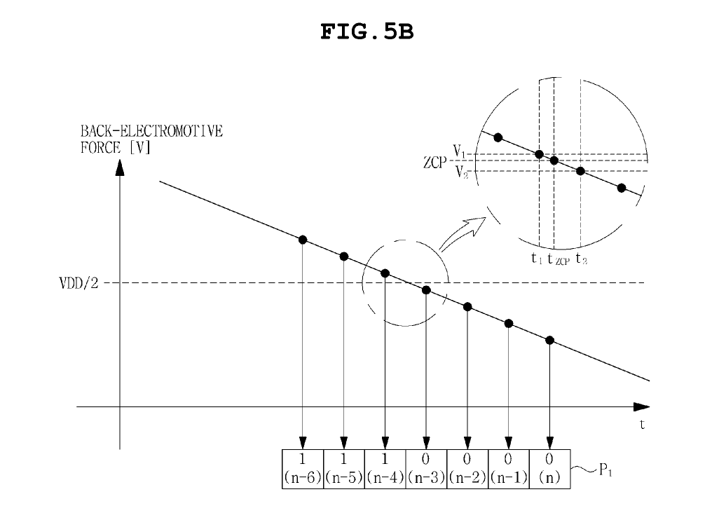

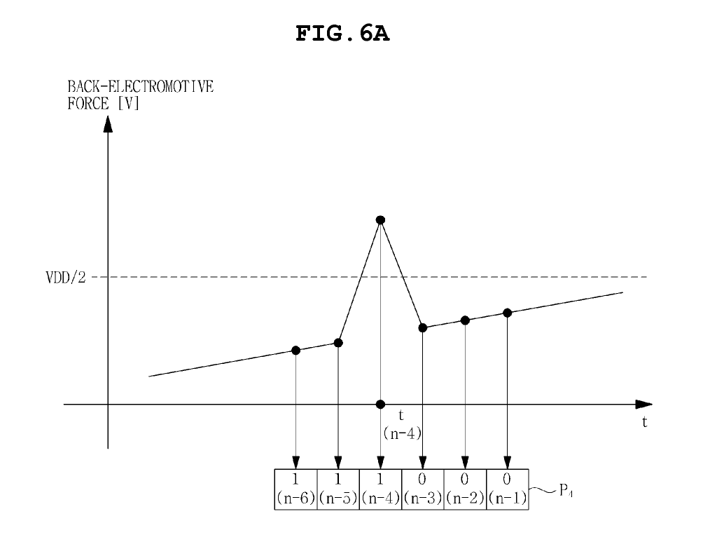

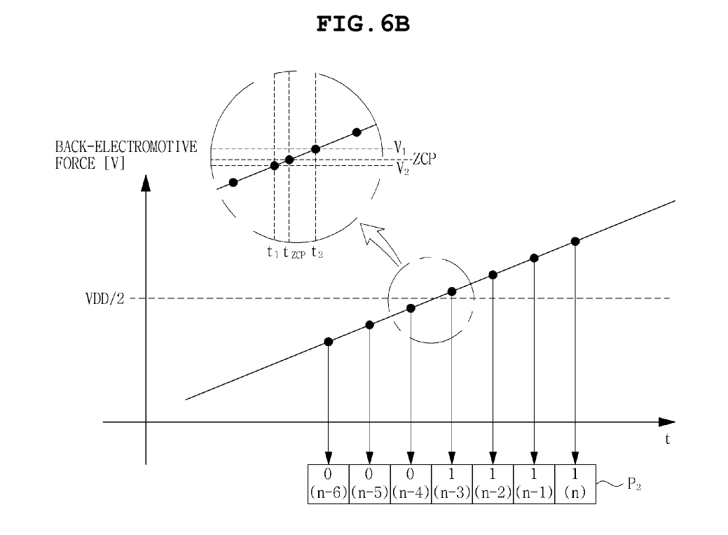

Next, a process of detecting ZCPs in floating sections of the respective phases in the ZCP detecting unit according to a preferred embodiment of the present invention will be described in more detail with reference to FIGS. 5A to 6B.

FIGS. 5A and 6A are diagrams showing the case in which an error may occur in detecting ZCPs or ZCP generation times (t_{ZCP}) because of noise that may be generated in a process of sampling back-electromotive force values in floating sections of the respective phases due to a mismatch of inductances, a vibration, or the like; and FIGS. 5B and 6B are diagrams showing contents capable of preventing the error in detecting the ZCPs or the ZCP generation times (t_{ZCP}), which may occur in FIGS. 5A and 6A. Although a description will be provided in connection with floating sections (sections \textcircled{1} and \textcircled{2}) of the U phase of FIG. 2B, it may be commonly applied to floating sections of the respective phases of the BLDC motor.

As shown in FIGS. 5A and 6A, in a process of sequentially sampling back-electromotive force values (n−6) to (n−1) in the floating sections (sections \textcircled{1} and \textcircled{2}) of the U phase of FIG. 2B, converting the sampled back-electromotive force values into digital values, and sequentially accumulating comparison result values between the back-electromotive force values converted into digital values and a reference voltage V_{DD}/2 by the digital comparator 114 to form a pattern (P₃ or P₄) of back-electromotive force, noise is generated in a specific back-electromotive force value due to an external vibration, or the like, such that a change is generated in the comparison result values (0ₙ₋₄ or 1ₙ₋₄) for the back-electromotive force values. Therefore, the ZCP detecting unit 110 judges that ZCPs have been generated by the comparison result values and performs phase shifting using position information of the ZCPs, thereby making it possible to cause a malfunction of the BLDC motor.

Therefore, 1) as shown in FIGS. 5B and 6B, i) back-electromotive force values are sequentially sampled in the floating sections (sections \textcircled{1} and \textcircled{2}) of the U phase of FIG. 2 by the analog multiplexer 111 and are converted into digital values by the converting module 112, ii) the back-electromotive force values converted into the digital values are sequentially stored in the first to fifth registers 113a to 113f of the first storing module 113, comparison result values between the back-electromotive force values converted into the digital values and a reference voltage V_{DD}/2 by the digital comparator 114 are sequentially accumulated by the pattern detecting module 117 (1₍ₙ₋₆₎, 1₍ₙ₋₅₎, 1₍ₙ₋₄₎ . . . or 0₍ₙ₋₆₎, 0₍ₙ₋₅₎, 0₍ₙ₋₄₎ . . . ), thereby making it possible to form a pattern (P₁ or P₂) of back-electromotive force.

In addition, the controller 118 iv) judges that ZCPs have been detected in the case in which the comparison result values (0₍ₙ₋₃₎ or 1₍ₙ₋₃₎) sequentially accumulated in the pattern (P₁ or P₂) of the back-electromotive force are changed, thereby making it possible to control the ZCP calculating module 115 to calculate ZCP generation times (t_{ZCP}) using the above Equations 1 and 2 based on position information [(V₁,t₁)ₙ₋₄ and (V₂,t₂)ₙ₋₃] of the comparison result values (0₍ₙ₋₃₎ or 1₍ₙ₋₃₎ and v) judges that the ZCPs and the ZCP generation times (t_{ZCP}) are valid only in the case in which comparison result values having the same value after the comparison result values form patterns (0₍ₙ₋₂₎, 0₍ₙ₋₁₎, 0ₙ or 1₍ₙ₋₂₎, 1₍ₙ₋₁₎, 1ₙ) continuously accumulated three times or more, thereby making it possible to perform phase shifting based on the ZCP generation times (t_{ZCP}).

As described above, with the apparatus for driving a motor and the controlling method thereof according to a preferred embodiment of the present invention, the ZCP detecting unit detects the ZCPs of the respective phases using the information of the changed comparison result values in the case in which a change in the comparison result values sequentially accumulated in the pattern of the back-electromotive force in the floating sections of the respective phases is sensed and judges the validity of the ZCPs depending on whether or not the comparison result values accumulated after the changed comparison result values form a predetermined pattern, thereby making it possible to accurately detect the ZCPs and the ZCP generation times even in the case in which noise is generated in actual ZCPs due to a mismatch of inductors, or the like, a vibration, or the like. Therefore, stability of driving of the motor accompanied with accurate phase shifting may be secured.

According to a preferred embodiment of the present invention, in a sensorless scheme of detecting the ZCPs through the back-electromotive force of the respective phases to find position information of the rotor, the ZCP detecting unit of the BLDC motor sequentially samples the back-electromotive force values in the floating sections of the respective phases, forms the pattern of the back-electromotive force using the comparison result values between the back-electromotive force values and the reference voltage value (voltage at a neutral point) by the digital comparator, and detects the position information of the ZCPs depending on whether or not the comparison result values on the pattern of the back-electromotive force have been changed, thereby making it possible to more accurately detect the position information of the ZCPs of the respective phases as compared with the case of detecting the ZCPs of the respective phases by an analog comparator.

Further, according to a preferred embodiment of the present invention, the ZCP detecting unit detects the ZCPs of the respective phases using the information of the changed comparison result values in the case in which a change in the comparison result values sequentially accumulated in the pattern of the back-electromotive force in the floating sections of the respective phases is sensed and judges the validity of the ZCPs depending on whether or not the comparison result values accumulated after the changed comparison result values form a predetermined pattern, thereby making it possible to accurately detect the ZCPs and the ZCP generation times even in the case in which noise is generated in actual ZCPs due to a mismatch of inductors, or the like, a vibration, or the like. Therefore, stability of driving of the motor accompanied with accurate phase shifting may be secured.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for driving a motor, comprising:
a rectifying unit rectifying alternative current (AC) input power to generate direct current (DC) power;
an inverter applying the DC power to the respective phases of the motor through a switching operation thereof; and
a motor driver converting back-electromotive force values sequentially sampled in floating sections of the respective phases into digital values and detecting position information of zero crossing points (ZCPs) of the respective phases through a pattern of back-electromotive force formed using comparison result values between the digital values and a reference voltage value.

2. The apparatus for driving a motor as set forth in claim 1, wherein the motor driver converts the back-electromotive force values into the digital values by an analog-to-digital converter.

3. The apparatus for driving a motor as set forth in claim 1, wherein the motor driver compares the back-electromotive force values converted into the digital values with the reference voltage value by a digital comparator to output the comparison result values.

4. The apparatus for driving a motor as set forth in claim 3, wherein the motor driver sequentially accumulates the comparison result values to form the pattern of the back-electromotive force.

5. The apparatus for driving a motor as set forth in claim 4, wherein the motor driver detects the position information of the ZCPs of the respective phases using position information of the changed comparison result values in the case in which the comparison result values sequentially accumulated in the pattern of the back-electromotive force have been changed.

6. The apparatus for driving a motor as set forth in claim 5, wherein the motor driver judges validity of the position information of the ZCPs depending on whether or not comparison result values accumulated after the changed comparison result values form a predetermined pattern in the case in which the comparison result values sequentially accumulated in the pattern of the back-electromotive force have been changed.

7. The apparatus for driving a motor as set forth in claim 6, wherein the motor driver performs phase shifting of the respective phases on the assumption that the position information of the ZCPs is valid in the case in which comparison result values having the same value after the changed comparison result values form a pattern continuously accumulated three times or more.

8. The apparatus for driving a motor as set forth in claim 7, wherein the motor driver sequentially stores the back-electromotive force values converted into the digital values by a first storing module.

9. The apparatus for driving a motor as set forth in claim 8, wherein the motor driver sequentially stores the comparison result values by a second storing module.

10. The apparatus for driving a motor as set forth in claim 9, wherein the motor driver generates pulse width modulation (PWM) signals for controlling the switching operation of the inverter and the phase shifting of the respective phases using the position information of the ZCPs.

11. The apparatus for driving a motor as set forth in claim 1, wherein the motor driver includes:
a ZCP detecting unit converting the respective back-electromotive force values sequentially sampled in the floating sections of the respective phases into the digital values and detecting the position information of the ZCPs of the respective phases through the pattern of the back-electromotive force formed using the comparison result values between the digital values and the reference voltage value; and
a PWM signal generating unit generating PWM signals for controlling the switching operation of the inverter and phase shifting of the respective phases using the position information of the ZCPs.

12. The apparatus for driving a motor as set forth in claim 11, wherein the ZCP detecting unit includes:
an analog multiplexer sequentially transmitting the back-electromotive force values sampled in the floating sections of the respective phases;
a converting module converting the back-electromotive force values of the respective phases transmitted from the analog multiplexer into the digital values;
a digital comparator comparing the back-electromotive force values converted into the digital values with a preset reference voltage value to output the comparison result values;
a back-electromotive force pattern detecting module forming the pattern of the back electromotive force using the comparison result values so that the comparison result values and the sampled back-electromotive force values correspond to each other;
a ZCP calculating module calculating ZCP generation times (t_{ZCP}) using the position information of the ZCPs in the case in which the comparison result values configuring the pattern of the back-electromotive force are changed; and
a controller judging validity of the position information of the ZCPs and the ZCP generation times (t_{ZCP}) depending on whether or not the comparison result values input from the digital comparator after the comparison result values are changed form a predetermined pattern.

13. The apparatus for driving a motor as set forth in claim 12, wherein the ZCP detecting unit includes a first storing module including first to fifth registers in which the back-electromotive force values converted into the digital values are sequentially stored.

14. The apparatus for driving a motor as set forth in claim 13, wherein the ZCP detecting unit includes a second storing module including first to sixth registers in which the comparison result values are sequentially stored.

15. A controlling method of an apparatus for driving a motor, comprising:
rectifying, by a rectifying unit, AC input power to generate DC power;
applying the DC power to the respective phases of the motor through a switching operation of an inverter; and
converting back-electromotive force values sequentially sampled in floating sections of the respective phases into digital values and detecting position information of ZCPs of the respective phases through a pattern of back-electromotive force formed using comparison result values between the digital values and a reference voltage value.

16. The controlling method of an apparatus for driving a motor as set forth in claim 15, wherein the detecting of the position information of the ZCPs of the respective phases includes:
sequentially transmitting the back-electromotive force values sampled in the floating sections of the respective phases;
converting the back-electromotive force values of the respective phases that are transmitted into the digital values;
comparing the back-electromotive force values converted into the digital values with a preset reference voltage value to output the comparison result values;
sequentially accumulates the comparison result values to form the pattern of the back-electromotive force;
detecting whether or not the ZCPs have been generated and ZCP generation times (t_{ZCP}) depending on whether or not the comparison result values configuring the pattern of the back-electromotive force has been changed; and
judging validity of the position information of the ZCPs depending on whether or not comparison result values accumulated after the changed comparison result values form a predetermined pattern in the case in which the comparison result values sequentially accumulated in the pattern of the back-electromotive force have been changed.

17. The controlling method of an apparatus for driving a motor as set forth in claim 16, wherein the detecting of the position information of the ZCPs of the respective phases further includes, after the converting of the back-electromotive force values of the respective phases into the digital values, sequentially storing back-electromotive force values converted into the digital values in first to fifth registers.

18. The controlling method of an apparatus for driving a motor as set forth in claim 17, wherein the detecting of the position information of the ZCPs of the respective phases further includes, after the outputting of the comparison result values, sequentially storing the comparison result values in first to sixth registers.
